(19) United States
(12) Patent Application Publication
(10) Pub. No.: US 2026/0032785 A1
(43) Pub. Date: Jan. 29, 2026

(54) CONTROLLER, BONDING SYSTEM, NON-TRANSITORY COMPUTER-READABLE STORAGE MEDIUM, AND SETTING METHOD

(71) Applicant: NIPPON AVIONICS CO., LTD., Yokohama-shi (JP)

(72) Inventor: Tadahiro IWATSUKI, Yokohama-shi (JP)

(21) Appl. No.: 19/058,984

(22) Filed: Feb. 20, 2025

(30) Foreign Application Priority Data
Jul. 25, 2024 (JP) 2024-119639

(51) Int. Cl. H05B 1/02; B23K 20/02

(52) U.S. Cl. CPC H05B 1/023; B23K 20/023

(57) ABSTRACT

A controller for controlling power supplied to a heater tool, the heater tool heating a work by generating heat by the power, thereby bonding a first part and a second part of the work, includes: an acquisition unit configured to acquire at least one pair of a resistance value and a temperature of the heater tool when a current is caused to flow to the heater tool before the first part and the second part are bonded; a setting unit configured to derive, based on the at least one pair acquired by the acquisition unit, a resistance value of the heater tool when a temperature of the heater tool becomes a bonding temperature necessary for bonding the first part and the second part, and set the derived resistance value as a target resistance value; and a control unit configured to measure a resistance value of the heater tool when the first part and the second part are bonded, and configured to control, when the first part and the second part are bonded, the power based on the measured resistance value so that a resistance value of the heater tool reaches the target resistance value.

### TECHNICAL FIELD

The present disclosure relates to a controller, a bonding system, a non-transitory computer-readable storage medium, and a setting method.

### BACKGROUND

As disclosed in Patent Literature 1 (Japanese Patent Laid-Open No. 2003-236675), there is known a technique of bonding a first part and a second part of a work by heating the work by heat generated by a heater tool. In the technique described in Patent Literature 1, the temperature of the heater tool (power supplied to the heater tool) is controlled based on the resistance value of the heater tool.

According to the technique described in Patent Literature 1, it is possible to control the temperature of the heater tool without using a thermocouple or the like but Patent Literature 1 does not disclose a method of setting a target resistance value of the heater tool for obtaining a desired heating temperature. The target resistance value is obtained based on a resistance temperature coefficient representing a ratio of a change of the resistance value when the temperature of a conductor rises by 1° C., and the temperature of the heater tool and the resistance value of the heater tool at this temperature (for example, room temperature and the resistance value at the room temperature). The pair of the temperature and the resistance value varies depending on the individual difference even for the same kind of heater tool. Therefore, the preferable target resistance value changes depending on the heater tool. As a result, the accuracy of temperature control may be low depending on the heater tool.

### SUMMARY

an objective of the present disclosure is to implements fine temperature control regardless of the individual difference of a heater tool.

To achieve the above objective, a controller for controlling power supplied to a heater tool, the heater tool heating a work by generating heat by the power, thereby bonding a first part and a second part of the work, comprising: an acquisition unit configured to acquire at least one pair of a resistance value and a temperature of the heater tool when a current is caused to flow to the heater tool before the first part and the second part are bonded; a setting unit configured to derive, based on the at least one pair acquired by the acquisition unit, a resistance value of the heater tool when a temperature of the heater tool becomes a bonding temperature necessary for bonding the first part and the second part, and set the derived resistance value as a target resistance value; and a control unit configured to measure a resistance value of the heater tool when the first part and the second part are bonded, and configured to control, when the first part and the second part are bonded, the power based on the measured resistance value so that a resistance value of the heater tool reaches the target resistance value.

A bonding system according to the present disclosure comprises the above-described controller, and a bonding apparatus controlled by the controller, including a heater tool, and configured to bond a first part and a second part by the heater tool.

A non-transitory computer-readable storage medium according to the present disclosure storing a program for causing a computer to function as the above-described controller.

A setting method according to the present disclosure is a setting method of setting a target resistance value in a controller configured to control power supplied to a heater tool configured to heat a work by generating heat by the power, thereby bond a first part and a second part of the work, wherein the controller is configured to measure a resistance value of the heater tool when the first part and the second part are bonded, and controls, when the first part and the second part are bonded, the power based on the measured resistance value so that a resistance value of the heater tool reaches the target resistance value, the method comprising: performing, at least once, processing of causing a current to flow to the heater tool and measuring a resistance value and a temperature of the heater tool, thereby acquiring at least one pair of the resistance value and the temperature of the heater tool; deriving, based on the acquired at least one pair acquired, a resistance value of the heater tool when a temperature of the heater tool becomes a bonding temperature necessary for bonding the first part and the second part; and setting the derived resistance value as the target resistance value.

### BRIEF DESCRIPTION OF DRAWINGS

FIG. 1 is a view illustrating a bonding system according to an embodiment of the present disclosure.

FIG. 2 is a view illustrating an example of a partial configuration of the bonding system shown in FIG. 1.

FIG. 3 is a flowchart of target resistance value setting processing.

FIG. 4 is a view illustrating an example of a partial configuration of the bonding system in a case where the temperature of a heater tool is measured using a temperature sensor.

FIG. 5 is a flowchart of bonding processing.

FIG. 6A is a graph illustrating a temporal change of the resistance value of the heater tool

FIG. 6B is a graph illustrating a temporal change of the power supplied to the heater tool.

### DETAILED DESCRIPTION

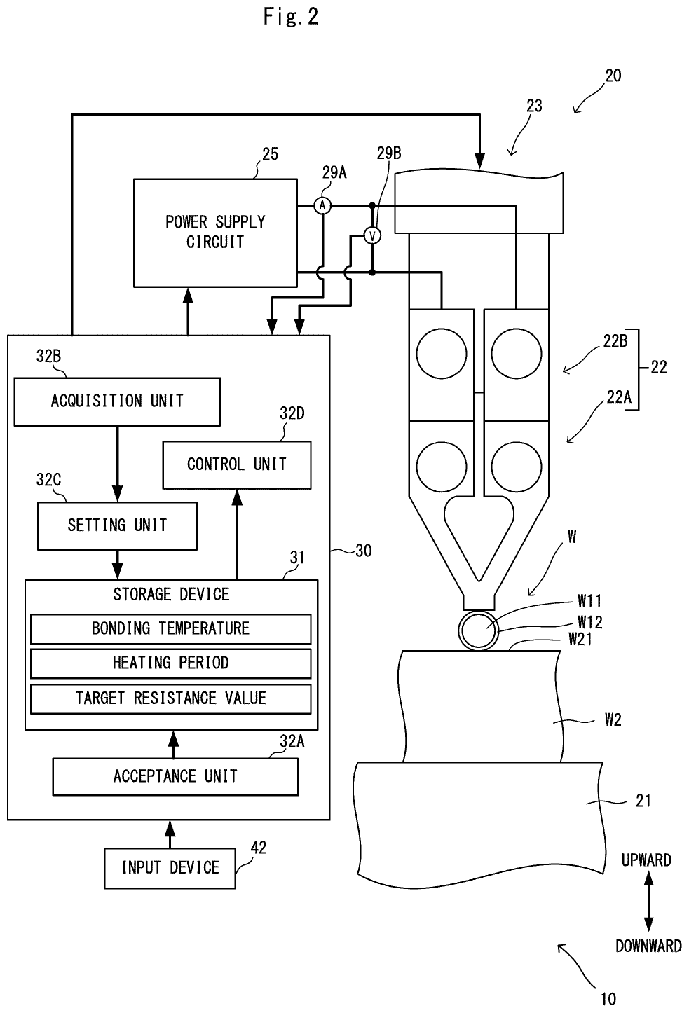

An embodiment of the present disclosure will be described below with reference to the accompanying drawings. Note that the upward-downward direction is shown in FIG. 2 for the sake of convenience and may or may not match the actual vertical direction.

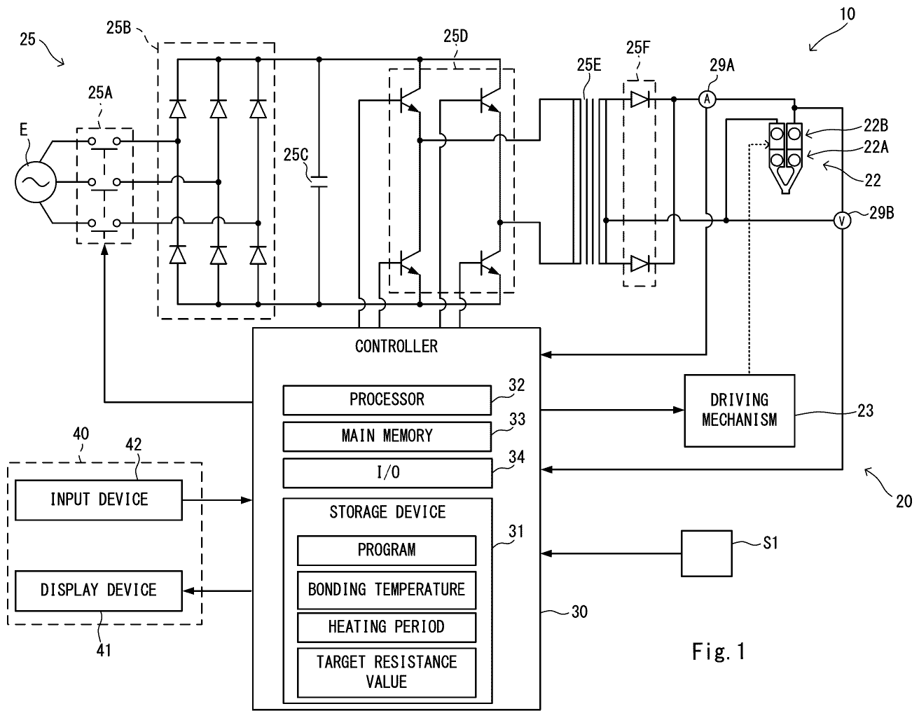

As shown in FIGS. 1 and 2, a bonding system 10 according to this embodiment includes a bonding apparatus 20, a controller 30, and an interface 40 (FIG. 1).

The bonding apparatus 20 heats a work W (FIG. 2), and bonds parts W1 and W2 forming the work W by thermocompression bonding using the pulse heat. The parts W1 and W2 form a chip inductor. The part W1 is a coated wire forming a coil, and includes a core wire W11 and a coating film W12. The part W2 is a plate-shaped member including an electrode W21 to which the core wire W11 is bonded by thermocompression bonding. At the time of thermocompression bonding, the coating film W12 is removed by heat, and the core wire W11 is thermocompression-bonded to the electrode W21. A chip inductor is completed by the thermocompression bonding.

As shown in FIG. 2, the bonding apparatus 20 includes a stage 21 that supports the work W, a heater tool 22 that heats the work W by generating heat and bonds the parts W1 and W2, and a driving mechanism 23 that presses the heater tool 22 against the work W (in this example, the part W1). The bonding apparatus 20 further includes a power supply circuit 25 that supplies power to the heater tool 22 and causes the heater tool 22 to generate heat, an ammeter 29A that detects the current flowing to the heater tool 22, a voltmeter 29B that detects the voltage applied to the heater tool 22, and a temperature sensor S1 that detects the temperature of the heater tool 22.

The heater tool 22 includes a heater tip 22A that is formed from a heating resistor made of molybdenum (Mo), tungsten (W), or the like and contacts the work W to actually heat the work W, and a support member 22B that is formed from a low resistor made of copper or the like and supports the heater tip 22A from an upward position. Power that causes the heater tip 22A to generate heat is supplied from the power supply circuit 25 to the heater tip 22A via the support member 22B. The heater tip 22A is a consumable that deteriorates by use, and is thus attached to the support member 22B to be replaceable by a new heater tip. For example, the heater tip 22A is detachably fixed to the support member 22B by a bolt. The support member 22B is preferably a low resistor so as not to consume power supplied to the heater tip 22A. Various plating methods such as gold plating may be applied to the support member 22B.

The driving mechanism 23 includes a linear motor or the like. The driving mechanism 23 moves the heater tool 22 in the upward-downward direction. The driving mechanism 23 moves the heater tool 22 downward to press the heater tip 22A against the work W. By the pressing, the driving mechanism 23 sandwiches the work W by the lower end of the heater tip 22A and the upper surface of the stage 21 to apply a pressure.

As shown in FIG. 1, the power supply circuit 25 includes a switch 25A connected to an external power supply E, a rectifier circuit 25B provided at the succeeding stage of the switch 25A, a smoothing capacitor 25C provided at the succeeding stage of the rectifier circuit 25B, and an inverter 25D provided at the succeeding stage of the smoothing capacitor 25C. The power supply circuit 25 further includes a transformer 25E provided at the succeeding stage of the inverter 25D, and a rectifier portion 25F including a plurality (in this example, two) of diodes provided at the succeeding stage of the transformer 25E. The rectifier portion 25F is connected to the heater tool 22.

The switch 25A supplies AC power (in this example, 3-phase AC power) from the external power supply E to the rectifier circuit 25B in an ON state, and does not supply the AC power to the rectifier circuit 25B in an OFF state. The rectifier circuit 25B includes a bridge diode, and rectifies the AC power from the external power supply E. The smoothing capacitor 25C smooths the AC power rectified by the rectifier circuit 25B. The smoothed AC power, that is, DC power is input to the inverter 25D. The inverter 25D includes a plurality of switching elements that are bridge-connected, and converts the input DC power into AC power through the switching operation of each switching element. The inverter 25D may be further includes an inductor or a capacitor and a reflux diode connected to each switching element in series or in parallel, and may be formed as a current or voltage type inverter.

The converted AC power is input to the primary side of the transformer 25E and transformed (lowered in this example). The transformed AC power is output from the secondary side of the transformer 25E. The AC power output from the secondary side is full-wave rectified by the rectifier portion 25F. The power full-wave rectified by the rectifier portion 25F is supplied to the heater tool 22 via the support member 22B. This causes a current to flow to the heater tip 22A of the heater tool 22, and the heater tip 22A generates heat by Joule heat generated by the current. The rectifier portion 25F may include a capacitor that smooths the rectified power.

The power supplied to the heater tool 22 is controlled by the switching operation of each switching element in inverter 25D. By controlling switching operation, for example, a period at which the switching element is turned on and/or a duty ratio of a pulse signal that turns on/off the switching element is adjusted. As a result, the power supplied to the heater tool 22 (particularly, the heater tip 22A) is controlled. As control of switching operation, for example, PWM (Pulse Width Modulation) control is used. The switching operation of each switching element is controlled by the controller 30.

The ammeter 29A is connected so as to detect the current flowing to the heater tool 22. The voltmeter 29B is connected so as to detect the voltage applied to the heater tool 22. The current value and the voltage value detected by the ammeter 29A and the voltmeter 29B, respectively, are input to the controller 30.

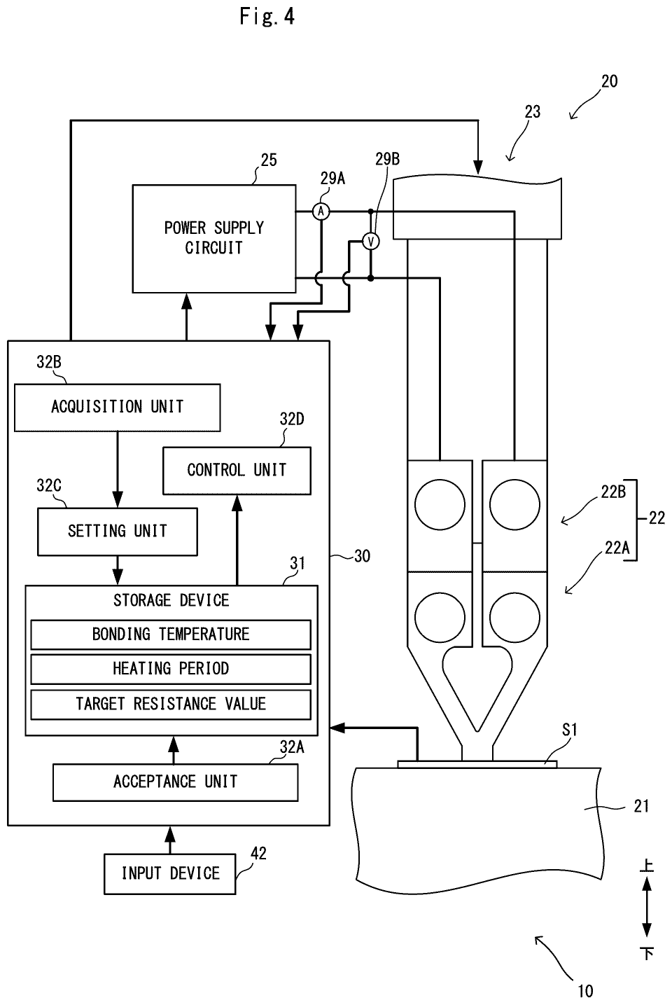

The temperature sensor S1 is configured to detect the temperature of the heater tool 22 at the time of setting a target resistance value (to be described later). More specifically, the temperature sensor S1 is installed on the stage 21 at the time of setting the target resistance value (to be described later), and contacts the lower end of the heater tip 22A of the heater tool 22 moved downward by the driving mechanism 23, that is, a heating portion that heats the work W (see FIG. 4). This contact sets the temperature sensor S1 in a state in which it is possible to detect the temperature of the heater tool 22 (more specifically, the heating portion of the heater tip 22A). At the time of bonding the parts W1 and W2 of the work W, the temperature sensor S1 is arranged outside the stage 21 so as not to interfere with the bonding. The temperature sensor S1 inputs the detected temperature to the controller 30. The temperature sensor S1 is formed by an arbitrary sensor such as a sheet thermocouple.

The controller 30 is configured to control the operation of the bonding apparatus 20. In particular, the controller 30 is configured to bond the parts W1 and W2 of the work W by controlling the driving mechanism 23 and the power supply circuit 25. The controller 30 is particularly configured to control switching operation of each switching element of the inverter 25D and thus control power supplied to the heater tool 22.

The controller 30 includes a nonvolatile storage device 31 that stores various kinds of data, a program, and the like, and a processor 32 that performs processing (to be described later) by executing the program and using the various kinds of data. The various kinds of data stored in the storage device 31 include a bonding temperature, a heating period, and a target resistance value. Details of the pieces of information will be described later. The processor 32 includes a CPU (Central Processing Unit). The controller 30 further includes a main memory 33 that provides a work area used by the processor 32, and an I/O (Input/Output) 34 that relays data transmitted/received between the processor 32 and the external apparatus of the controller 30. The I/O (Input/Output) 34 can include an analog/digital conversion circuit that converts, into a digital signal, each of analog signals respectively representing the current value and the voltage value input from the ammeter 29A and the voltmeter 29B to the controller 30 and supplies the digital signal to the processor 32.

The processor 32 operates as each of an acceptance unit 32A, an acquisition unit 32B, a setting unit 32C, and a control unit 32D shown in FIG. 2 by executing the program in the storage device 31. Details of these units will be described later.

The interface 40 includes a display device 41 that displays various operation images, and an input device 42 that receives an operation from an operator of the controller 30 (for example, a user) or information from an external apparatus. The input device 42 may be, for example, a transparent touch pane provided on the screen of the display device 41 to accept a touch operation from the operator of the controller 30, or an operation input device including various operation keys.

As described above, the processor 32 of the controller 30 operates as each of the acceptance unit 32A, the acquisition unit 32B, the setting unit 32C, and the control unit 32D.

The acceptance unit 32A accepts various parameters at the time of bonding, which are input to the input device 42 by the operator. The various parameters include bonding conditions for bonding the parts W1 and W2. The bonding conditions include a bonding temperature at which the parts W1 and W2 are bonded, and a heating period during which the parts W1 and W2 are heated at the bonding temperature. The bonding conditions further include first power and second power (to be described later). The bonding conditions are derived in advance by an experiment and/or various calculation processes. The acceptance unit 32A sets the various parameters accepted by the acceptance unit 32A in the controller 30, by storing the various parameters in a predetermined storage area of the storage device 31. Note that a plurality of candidates of the various parameters may be preset in the controller 30, and the acceptance unit 32A may display the plurality of candidates on the display device 41. In this case, the operator sets the various parameters by operating the input device 42 to select one of the plurality of candidates and edit the candidate as needed.

The acquisition unit 32B and the setting unit 32C are configured to set a target resistance value used at the time of bonding the parts W1 and W2 before a full operation by the bonding apparatus 20, that is, before bonding is performed for each of many works W in the mass production process of tip inductors. In this embodiment, the heating of the work W is controlled based on the resistance value of the heater tool 22. The target resistance value is a resistance value corresponding to the bonding temperature designated by the operator, and is set as the target value of the resistance value in control based on the resistance value.

Before the parts W1 and W2 are bonded, the acquisition unit 32B performs, a plurality of times, acquisition processing of causing a current to flow to the heater tool 22 and acquiring the resistance value and the temperature of the heater tool 22 at the time of causing the current to flow. Thus, the acquisition unit 32B acquires a plurality of pairs of resistance values and temperatures. One pair of a resistance value and a temperature of the plurality of pairs is acquired by one acquisition process. The current caused to flow to the heater tool 22 is made different in each acquisition process. The acquisition unit 32B measures the resistance value of the heater tool 22 by dividing the voltage detected by the voltmeter 29B by the current detected by the ammeter 29A. The acquisition unit 32B acquires the resistance value by this measurement. The acquisition unit 32B acquires the temperature of the heater tool 22 by measuring the temperature by the temperature sensor S1 shown in FIG. 1.

The setting unit 32C derives, based on the plurality of pairs of the resistance values and the temperatures acquired by the acquisition unit 32B, the resistance value of the heater tool 22 when the temperature of the heater tool 22 reaches the above set bonding temperature The setting unit 32C sets the derived resistance value as the target resistance value. The relationship between the resistance value and the temperature of the heater tool 22 is given by equation (1) below. In equation (1), R_{Te1} [Ω] and Te1 [ ° C.] represent the resistance value and the temperature of the heater tool 22 acquired by the acquisition unit 32B, Te2 [° C.] represents the bonding temperature of the heater tool 22, R_{Te2} [Ω] represents the resistance value of the heater tool 22 at Te2 [° C.], and α [1/° C.] represents the resistance temperature coefficient of the heater tool 22. As indicated by equation (1), the resistance value and the temperature of the heater tool 22 linearly change. The setting unit 32C derives and sets the target resistance value by using the correlation between the resistance value and the temperature.

$${R}_{Te 2} = {R}_{Te 1} \{ 1 + α ( Te 2 ‐ Te 1 ) \} \qquad ( 1 )$$

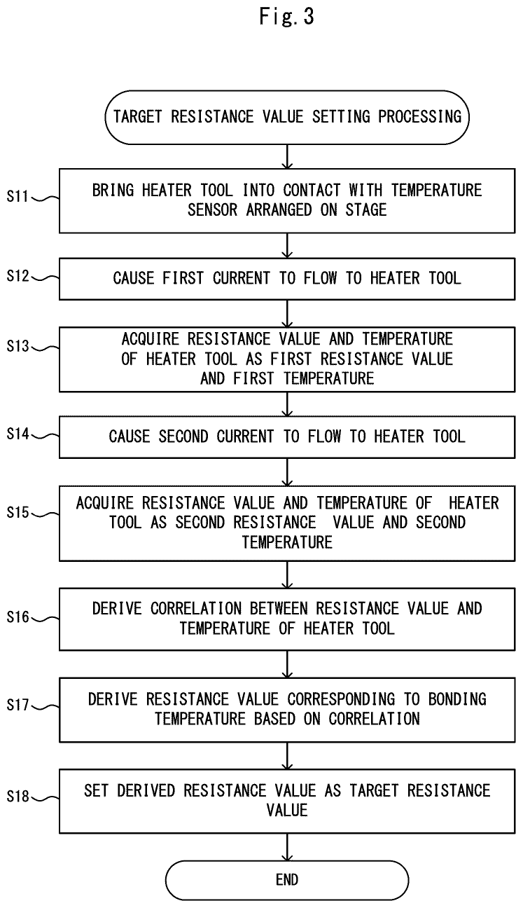

The acquisition unit 32B and the setting unit 32C execute, for example, target resistance value setting processing shown in FIG. 3. Before executing the target resistance value setting processing, the operator arranges the temperature sensor S1 on the stage 21.

In the target resistance value setting processing shown in FIG. 3, first, the acquisition unit 32B controls the driving mechanism 23 to move the heater tool 22 downward, thereby bringing the lower end of the heater tool 22, that is, the lower end of the heater tip 22A into contact with the temperature sensor S1, as shown in FIG. 4 (step S11). This lower end is a portion that contacts the work W and generates heat when heating the work W, and transfers the generated heat to the work W.

After that, the acquisition unit 32B operates the power supply circuit 25 to cause a first current to flow to the heater tool 22 (step S12). The acquisition unit 32B measures, as a first resistance value and a first temperature, the resistance value of the heater tool 22 (in this example, the resistance value of the overall heater tool 22) and the temperature of the heater tool 22 (in this example, the temperature of the lower end as the heating portion of the heater tip 22A) when the first current flows, thereby acquiring them (step S13). The acquisition unit 32B holds the acquired first resistance value and first temperature in, for example, the main memory 33.

After that, the acquisition unit 32B operates the power supply circuit 25 to cause a second current having a current value different from a current value of the first current to flow to the heater tool 22 (step S14). The acquisition unit 32B measures, as a second resistance value and a second temperature, the resistance value and the temperature of the heater tool 22 when the second current flows (step S15). The acquisition unit 32B holds the acquired second resistance value and second temperature in, for example, the main memory 33.

The control mode of the power supply circuit 25 (that is, the switching operation mode of each switching element of the inverter 25D) for causing the first current and the second current to flow to the heater tool 22 is preset.

After that, the setting unit 32C derives the correlation between the resistance value and the temperature of the heater tool 22 based on the pair of the first resistance and the first temperature and the pair of the second resistance value and the second temperature (step S16). For example, the setting unit 32C substitutes the first resistance value and the second resistance value for R_{Te1} and R_{Te2} in equation (1) above, and substitutes the first temperature and the second temperature for Te1 and Te2, thereby driving the value of α in equation (1) as a correlation α1.

After that, the setting unit 32C derives, based on the derived correlation, a resistance value corresponding to the bonding temperature stored in the storage device 31 (step S17). For example, the setting unit 32C derives a resistance value by equation (2) below obtained by substituting the correlation α1 for a in equation (1) above. The setting unit 32C performs calculation by substituting the first temperature for Te1, the bonding temperature for Te2, and the first resistance value for R_{Te1}, and setting R_{Te2} as a resistance value to be derived here. The values substituted for Te1 and R_{Te1} may be the second temperature and the second resistance value, respectively.

$${R}_{Te 2} = {R}_{Te 1} \{ 1 + α 1 ( Te 2 - Te 1 ) \} \qquad ( 2 )$$

After that, the setting unit 32C sets, as the target resistance value, the resistance value derived by the calculation by equation (2) above (step S18). The resistance value is set as the target resistance value by being stored in a predetermined storage area of the storage device 31.

The control unit 32D bonds the parts W1 and W2 of the work W. At the time of the bonding, the control unit 32D measures the resistance value of the heater tool 22, and controls, based on the measured resistance value, power supplied to the heater tool 22 so that the resistance value of the heater tool 22 reaches the target resistance value set by the setting unit 32C. The power is controlled by controlling switching operation of the switching elements of the inverter 25D of the power supply circuit 25.

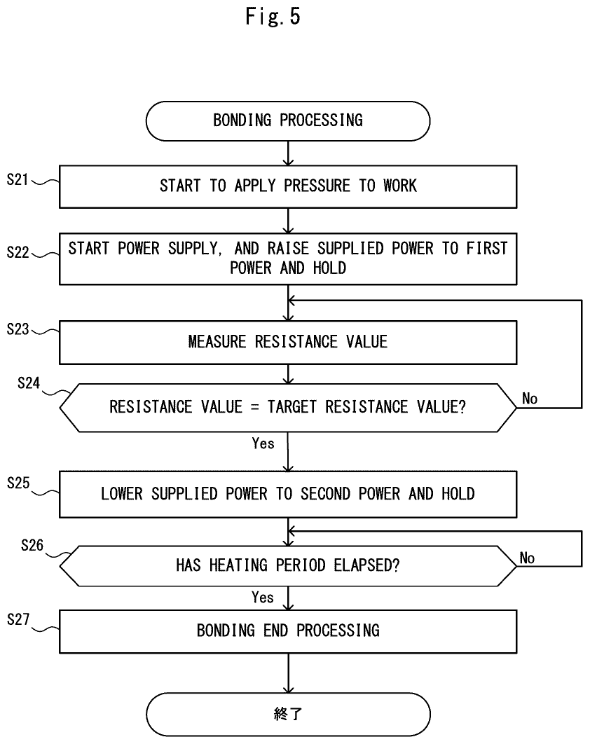

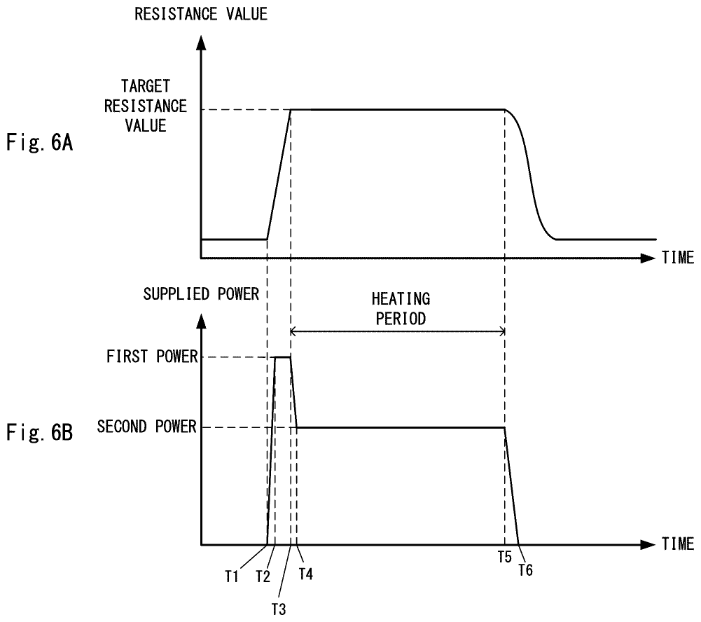

The control unit 32D executes, for example, bonding processing shown in FIG. 5. The bonding processing will be described below with reference to FIGS. 5, 6A, and 6B. FIGS. 6A and 6B are graphs illustrating the relationship between a temporal change of the resistance value of the heater tool 22 in the bonding processing and a temporal change of a power supplied to the heater tool 22 in the bonding processing.

In the bonding processing, first, the control unit 32D controls the driving mechanism 23 to move the heater tool 22 toward the work W, and causes the heater tool 22 to apply a pressure to the work W (step S21). This presses the part W1, on the side of the heater tool 22, of the work W against the part W2 on the opposite side.

After that, the control unit 32D operates the power supply circuit 25 to start power supply to the heater tool 22 (step S22). Furthermore, the power supply circuit 25 controls switching operation of the switching elements of the inverter 25D to raise the power supplied to the heater tool 22 to the first power (from a timing T1 to a timing T2 in FIG. 6), and then holding the first power (step S22, from the timing T2 to a timing T3). The first power is preset as power for causing the heater tool 22, more specifically, the heater tip 22A to generate heat at a temperature higher than the bonding temperature necessary for bonding of the work W. With the first power, the temperature of the heater tool 22 quickly reaches the bonding temperature.

After that, the control unit 32D measures the resistance value of the heater tool 22 at this time by acquiring the current value from the ammeter 29A and the voltage value from the voltmeter 29B and dividing the voltage value by the current value (step S23). The measured resistance value changes in accordance with the temperature of the heater tool 22, as described above.

After that, the control unit 32D determines whether the resistance value measured in step S23 has reached the target resistance value set by the setting unit 32C (step S24). The control unit 32D stands by until the resistance value reaches the target resistance value (NO in step S24). If the control unit 32D determines that the resistance value has reached the target resistance value (YES in step S24, at the timing T3), the control unit 32D lowers the power supplied to the heater tool 22 from the first power held at this time to the second power (from the timing T3 to a timing T4), and then holds the second power (step S25, from the timing T4 to a timing T5). The second power is preset as power supplied to the heater tool 22 when causing the heater tool 22 to generate heat at the bonding temperature.

The control unit 32D determines whether the above set heating period has elapsed from the timing T3 at which it is determined that the resistance value has reached the target resistance value (step S26).

The control unit 32D stands by before the heating period elapses (NO in step S26). When the heating period elapses (YES in step S26), the control unit 32D performs bonding end processing (step S27). In the bonding end processing, for example, the control unit 32D decreases the power supplied to the heater tool 22 or turns off all the switching elements of the inverter 25D to stop the power supply. Furthermore, the control unit 32D controls the driving mechanism 23 to separate the heater tool 22 from the work W. In this end processing, the control unit 32D may perform processing of cooling the heater tool 22 and the work W by a cooling apparatus (not shown).

The various parameters for implementing the above control, for example, a switching parameter for implementing the power supplied to the heater tool 22 to the first power or the second power, that represents the switching operation mode of each switching element of the inverter 25D and the like are specified and set by an experiment performed in advance or the like. The switching parameter for implementing the first power and the second power may automatically be set by the control unit 32D. In this case, the control unit 32D gradually increases the power supplied to the heater tool 22 by gradually changing the switching operation mode (switching parameter) of each switching element of the inverter 25D of the power supply circuit 25, and periodically measures the resistance value of the heater tool 22. The control unit 32D sets, as the switching parameter for implementing the second power, the switching parameter when the resistance value reaches the target resistance value. The control unit 32D derives the switching parameter for implementing power larger than the second power, and sets the derived switching parameter as the parameter for implementing the first power. As the switching parameter for implementing the first power, the switching parameter for implementing highest power that can be output from the inverter 25D may be set.

The control unit 32D may sequentially measure the resistance value of the heater tool 22 during at least a period from the timing T4 to the timing T5. In this case, the control unit 32D may use the measured resistance values as feedback values and the target resistance value as the target value of feedback control to perform feedback control of switching operation of each switching element of the inverter 25D of the power supply circuit 25 (that is, feedback control of the power supplied to the heater tool 22).

The control unit 32D may sequentially measure the resistance value of the heater tool 22 during the whole period from the timing T1 to the timing T5. In this case, the control unit 32D may use the measured resistance values as feedback values and the target resistance value as the target value of feedback control to perform feedback control of switching operation of each switching element of the inverter 25D of the power supply circuit 25.

As described above, according to this embodiment, the acquisition unit 32B is configured to perform, a plurality of times, acquisition processing of acquiring the resistance value and the temperature of the heater tool 22 when causing a current to flow the heater tool 22, thereby acquiring the more than one pair of the resistance value and the temperature. The setting unit 32C is configured to derive, based on the more than one pair of the resistance value and the temperature acquired by the acquisition unit 32B, the resistance value of the heater tool 22 when the temperature of the heater tool 22 (the temperature when the heater tool 22 generates heat) becomes the bonding temperature, and set the derived resistance value as the target resistance value. Furthermore, the control unit 32D is configured to control, based on the measured resistance value of the heater tool 22, the power supplied to the heater tool 22 so that the resistance value of the heater tool 22 reaches the target resistance value. In this configuration, since the target resistance value is set based on the resistance value and the temperature of the heater tool 22 when a current is caused to flow to the heater tool 22, the preferred target resistance value is set regardless of the individual difference of the heater tool 22. Therefore, temperature control is implemented regardless of the individual difference of the heater tool 22.

In this embodiment, the setting unit 32C is configured to derive the correlation between the resistance value and the temperature of the heater tool 22 based on the more than one pair of the resistance value and the temperature acquired when causing different currents to flow to the heater tool 22. Then, the setting unit 32C is configured to derive, based on the derived correlation, the resistance value when the temperature of the heater tool 22 becomes the bonding temperature, and set the derived resistance value as the target resistance value. According to equation (1), if the resistance temperature coefficient α that is the correlation is known, it is possible to derive the target resistance value only based on one pair of a resistance value and a temperature. However, if more than one pair of a resistance value and a temperature of the heater tool 22 are acquired as in this embodiment, even if the resistance temperature coefficient α of the heater tool 22 is unknown, the target resistance value is derived. Therefore, in this embodiment, even if the resistance temperature coefficient α of the heater tool 22 is unknown, fine temperature control is implemented regardless of the individual difference of the heater tool 22. In particular, if the heater tool 22 is formed from the heater tip 22A that generates heat to contact the work W and heat the work W, and the support member 22B that has a resistance lower than that of the heater tip 22A and supports the heater tip 22A, the resistance temperature coefficient α of the whole heater tool 22 is unknown, and thus such configuration is effective.

The correlation can be information representing the relationship between the resistance value and the temperature of the heater tool 22, and may be, for example, an expression representing the relationship between the resistance value and the temperature, other than the resistance temperature coefficient. The number of pairs of resistance values and temperatures acquired by the acquisition processing may be three or more. As the number of pairs is larger, the accuracy of the correlation is improved.

(Modifications) Various modifications can be made to the above-described embodiment. Modifications will be described below. At least part of each modification can be applied to the above-described embodiment, and can also be applied to other modifications.

(First Modification) For example, the acquisition unit 32B may be configured to perform the above acquisition processing once to acquire one pair of a resistance value and a temperature of the heater tool 22. For example, the acquisition unit 32B may be configured to perform the above acquisition processing at least once to acquire at least one pair of a resistance value and a temperature of the heater tool 22.

(Second Modification) The setting unit 32C may be configured to acquire the resistance temperature coefficient of the heater tool 22, and derive, based on the at least one pair of the resistance value and the temperature acquired by the acquisition unit 32B and based on the acquired resistance temperature coefficient, the resistance value of the heater tool 22 when the temperature of the heater tool 22 becomes the bonding temperature. In a case where the heater tool 22 includes the two or more kinds of members, as described above, the resistance temperature coefficient of the heater tool 22 is assumed to be the resistance temperature coefficient of the heater tip 22A that actually heats the work W by generating heat. For example, the setting unit 32C is configured to acquire the resistance temperature coefficient input from the operator via the input device 42. As another example, a table indicating the relationship between the material of the heater tip 22A and the resistance temperature coefficient of the heater tip 22A may be prepared in the storage device 31, and the setting unit 32C may be configured to, for example, acquire the resistance temperature coefficient corresponding to the material with reference to the table based on the material of the heater tip 22A input from the operator via the input device 42. This is effective in a case where the heater tool 22 is formed only from the heater tip 22A or in a case where the resistance value of the support member 22B is lower than that of the heater tip 22A and the resistance value of the support member 22B and the resistance temperature coefficient of the support member 22B can be neglected. This is also effective in a case where the resistance value of the contact portion with the work W of the heater tip 22A is different from the resistance value of remaining portions and is lower than the resistance value of the remaining portions, and the resistance value of the remaining portion and the resistance temperature coefficient of the remaining portion can be neglected. The setting unit 32C substitutes the resistance value, the temperature, the resistance temperature coefficient, and the boding temperature for R_{Te1}, Te1, α, Te2 in equation (1) above, respectively, thereby deriving the target resistance value R_{Te2}.

(Third Modification) The temperature of the heater tool 22 acquired by the acquisition processing may be manually measured by the operator and input to the controller 30 via the input device 42. Similarly, the resistance value of the heater tool 22 acquired by the acquisition processing may also be manually measured by the operator and input to the controller 30 via the input device 42. In this case, in the above acquisition processing, the acquisition unit 32B acquires the temperature and/or the resistance value input to the controller 30. Note that by measuring the resistance value and the temperature by the acquisition unit 32B, as described above, the labor of the operator is saved. At this time, by using the temperature sensor S1 that detects the temperature of the contact portion with the work W of the heater tool 22 to measure the temperature of the contact portion as the temperature of the heater tool 22, as described above, the relationship between the temperature and the resistance value becomes more correct, thereby improving the accuracy of the set target resistance value.

(Fourth Modification) Acquisition of the resistance value and the temperature by the acquisition unit 32B (particularly, acquisition by the above measurement) and setting of the target resistance value by the setting unit 32C based on the acquired resistance value and temperature (for example, target resistance value setting processing) may be repeatedly performed every time bonding is performed for a predetermined number of works W. Thus, even if the heater tool 22, more specifically, the heater tip 22A deteriorates by use, the target resistance value is set depending on the deterioration, thereby fine temperature control for the heater tool 22 is implemented. This effect is obtained particularly when the modification is applied to the above-described embodiment.

(Fifth Modification) The various components described in the above embodiment are arbitrary, and can be changed appropriately. For example, the processor 32 may be formed from at least one or a plurality of combinations of one or more CPUs, one or more ASICs (Application Specific Integrated Circuits), and one or more FPGAs (Field-Programmable Gate Arrays). The processor 32 can be said as a processing unit. A program is stored in a non-transitory computer-readable storage medium such as the nonvolatile storage device 31. In addition to the bonding system for performing thermocompression bonding, the present invention is applicable to a bonding system for bonding the parts W1 and W2 of the work W by welding or soldering using the heater tool. In addition, the resistance value handled by each of the units 32A to 32D is a resistance value itself. However, as another example of the resistance value, a value (for example, a voltage value and/or a current value) that can uniquely indicate the resistance value may be adopted.

(Setting Method of Target Resistance Value) Each of the above-described embodiment and modifications can be grasped as the setting method of the target resistance value in the controller 30. The controller 30 as the target of the setting method is configured to measure the resistance value of the heater tool 22 when the parts W1 and W2 are bonded, and control, based on the measured resistance value, power supplied to the heater tool 22 so that the resistance value of the heater tool 22 reaches the target resistance value. This setting method includes, for example, a first step of acquiring at least one pair of a resistance value and a temperature by performing, at least once, measurement processing of causing a current to flow to the heater tool 22 and measuring the resistance value and the temperature of the heater tool 22 before the parts W1 and W2 are bonded. This setting method includes, for example, a second step of deriving, based on the at least one pair of the resistance value and the temperature acquired in the first step, the resistance value of the heater tool 22 when the temperature of the heater tool 22 becomes the bonding temperature necessary for bonding the parts W1 and W2, and setting the derived resistance value as the target resistance value. The execution constituent of the first step and the second step need not be the controller 30, and may be a person or another apparatus. The first step and the second step can further be limited by a part of each of the above-described embodiment and modifications. The above setting method is a method of processing a controller before setting the target resistance value into a controller in which the target resistance value is set, and can be said as a method of producing a controller.

(Appendix) The above-mentioned configuration and variant examples are given below as an appendix. The configurations given below can be combined with each other.

(appendix 1) A controller for controlling power supplied to a heater tool, the heater tool heating a work by generating heat by the power, thereby bonding a first part and a second part of the work, comprising:
an acquisition unit configured to acquire at least one pair of a resistance value and a temperature of the heater tool when a current is caused to flow to the heater tool before the first part and the second part are bonded;
a setting unit configured to derive, based on the at least one pair acquired by the acquisition unit, a resistance value of the heater tool when a temperature of the heater tool becomes a bonding temperature necessary for bonding the first part and the second part, and set the derived resistance value as a target resistance value; and
a control unit configured to measure a resistance value of the heater tool when the first part and the second part are bonded, and configured to control, when the first part and the second part are bonded, the power based on the measured resistance value so that a resistance value of the heater tool reaches the target resistance value.

(appendix 2) The controller according to appendix 1, wherein
the acquisition unit is configured to acquire, as the at least one pair, more than one pair of a resistance value and a temperature of the heater tool when different currents are caused to flow to the heater tool, and
the setting unit is configured to derive a correlation between a resistance value and a temperature of the heater tool based on the more than one pair, and drive, based on the derived correlation, the resistance value of the hater tool when the temperature of the hater tool becomes the bonding temperature.

(appendix 3) The controller according to appendix 2, wherein
the heater tool includes a heater tip configured to heat the work by contacting the work and generating heat, and a support member having a resistance lower than a resistance of the heater tip and configured to support the heater tip,
the acquisition unit is configured to acquire, as the resistance value of the more than one pair, a resistance value of the whole heater tool, and
the control unit is configured to measure, as the resistance value when the first part and the second part are bonded, a resistance value of the whole heater tool.

(appendix 4) The controller according to appendix 1, wherein the setting unit is configured to acquire a resistance temperature coefficient of the heater tool, and derive, based on the at least one pair and the resistance temperature coefficient, the resistance value of the heater tool when the temperature of the heater tool becomes the bonding temperature.

(appendix 5) The controller according to appendix 4, wherein
the heater tool includes a heater tip configured to heat the work by contacting the work and generating heat, and a support member having a resistance lower than a resistance of the heater tip and configured to support the heater tip, and
the setting unit is configured to acquire a resistance temperature coefficient of the heater tip as the resistance temperature coefficient of the heater tool.

(appendix 6) The controller according to any one of appendixes 1-5, wherein the acquisition unit is configured to acquire the at least one pair by performing, at least once, processing of causing the current to flow to the heater tool and measuring the resistance value and the temperature of the heater tool at the time of causing the current to flow.

(appendix 7) The controller according to appendix 6, wherein the acquisition unit is configured to measure the temperature at the time of causing the current to flow by a temperature sensor configured to detect a temperature of a contact portion with the work of the heater tool.

(appendix 8) The controller according to any one of appendixes 1-7, wherein
the acquisition unit is configured to acquire again at least one pair of a resistance value and a temperature by performing again, at least once, the processing of causing a current to flow to the heater tool and measuring a resistance value and a temperature after a first part and a second part of each of a plurality of works are bonded by performing control of power by the control unit, and
the setting unit is configured to derive again, based on the at least one pair acquired again by the acquisition unit, a resistance value of the heater tool when a temperature of the heater tool becomes the bonding temperature, and update, as the target resistance value, the resistance value derived again.

(appendix 9) The controller according to any one of appendixes 1-8, comprising a processor that functions as the acquisition unit, the setting unit, and the control unit.

(appendix 10) A bonding system comprising:
a controller according to any one of appendixes 1-9; and
a bonding apparatus controlled by the controller, including a heater tool, and configured to bond a first part and a second part by the heater tool.

(appendix 11) A non-transitory computer-readable storage medium storing a program for causing a computer to function as a controller according to any one of appendixes 1-10.

(appendix 12) A setting method of setting a target resistance value in a controller configured to control power supplied to a heater tool configured to heat a work by generating heat by the power, thereby bond a first part and a second part of the work, wherein the controller is configured to measure a resistance value of the heater tool when the first part and the second part are bonded, and controls, when the first part and the second part are bonded, the power based on the measured resistance value so that a resistance value of the heater tool reaches the target resistance value, the method comprising:
a first step of performing, at least once, processing of causing a current to flow to the heater tool and measuring a resistance value and a temperature of the heater tool, thereby acquiring at least one pair of the resistance value and the temperature of the heater tool; and
a second step of deriving, based on the at least one pair acquired in the first step, a resistance value of the heater tool when a temperature of the heater tool becomes a bonding temperature necessary for bonding the first part and the second part, and setting the derived resistance value as the target resistance value.

(appendix 13) The setting method according to appendix 12, wherein
the first step includes a step of performing, a plurality of times with different current, processing of causing a current to flow to the heater tool and measuring a resistance value and a temperature of the heater tool, thereby acquiring, as the at least one pair, more than one pair of the resistance value and the temperature of the heater tool
the second step includes a step of deriving a correlation between a resistance value and a temperature of the heater tool based on the more than one pair, and driving, based on the derived correlation, the resistance value of the hater tool when the temperature of the hater tool becomes the bonding temperature.

(appendix 14) The setting method according to appendix 13, wherein
the heater tool includes a heater tip configured to heat the work by contacting the work and generating heat, and a support member having a resistance lower than a resistance of the heater tip and configured to support the heater tip,
the resistance value measured by the controller is a resistance value of the whole heater tool, and
the resistance value acquired in the first step is a resistance value of the whole heater tool.

(appendix 15) The setting method according to appendix 12, wherein the second step includes a step of acquiring a resistance temperature coefficient of the heater tool, and deriving, based on the at least one pair and the resistance temperature coefficient, the resistance value of the heater tool when the temperature of the heater tool becomes the bonding temperature.

(appendix 16) The controller according to appendix 15, wherein
the heater tool includes a heater tip configured to heat the work by contacting the work and generating heat, and a support member having a resistance lower than a resistance of the heater tip and configured to support the heater tip, and
the resistance temperature coefficient of the heater tool acquired in the second step is a resistance temperature coefficient of the heater tip.

(appendix 17) The controller according to any one of appendixes 12-16, wherein the first step includes a step of measuring the temperature at the time of causing the current to flow by a temperature sensor configured to detect a temperature of a contact portion with the work of the heater tool.

(appendix 18) The controller according to any one of appendixes 12-17, further comprising:
a third step, after a first part and a second part of each of a plurality of works by the heater tool, of performing, at least once, processing of causing a current to flow to the heater tool and measuring a resistance value and a temperature of the heater tool, thereby acquiring at least one pair of the resistance value and the temperature of the heater tool; and
a fourth step of deriving, based on the at least one pair acquired in the third step, a second resistance value of the heater tool when a temperature of the heater tool becomes the bonding temperature, and updating the derived second resistance value as the target resistance value.

(Scope of Invention) Although the present invention has been described with reference to the embodiment and the modifications thereof, the present invention is not limited to the above-described embodiment and modifications. For example, the present invention includes various changes done for the above-described embodiment and modifications, which can be understood by those who are skilled in the art within the technical concept of the present invention. The respective components exemplified in the above-described embodiment and modifications can appropriately be combined within the bounds of consistency. Furthermore, the components are arbitrarily omitted.

This application claims the benefit of Japanese Patent Application No. 2024-119639, filed on Jul. 25, 2024, the entire disclosure of which is incorporated by reference herein.

### EXPLANATION OF THE REFERENCE NUMERALS AND SIGNS

10 . . . bonding system, 20 . . . bonding apparatus, 21 . . . stage, 22 . . . heater tool, 22A . . . heater tip, 22B . . . support member, 23 . . . driving mechanism, 25 . . . power supply circuit, 25A . . . switch, 25B . . . rectifier circuit, 25C . . . smoothing capacitor, 25D . . . inverter, 25E . . . transformer, 25F . . . rectifier portion, 29A . . . ammeter, 29B . . . voltmeter, 30 . . . controller, 31 . . . storage device, 32 . . . processor, 32A . . . acceptance unit, 32B . . . acquisition unit, 32C . . . setting unit, 32D . . . control unit, 33 . . . main memory, 40 . . . interface, 41 . . . display device, 42 . . . input device, E . . . external power supply, S1 . . . temperature sensor, W . . . work, W1 . . . part, W2 . . . part, W11 . . . core wire, W12 . . . coating film, W21 . . . electrode

1. A controller for controlling power supplied to a heater tool, the heater tool heating a work by generating heat by the power, thereby bonding a first part and a second part of the work, comprising:
an acquisition unit configured to acquire at least one pair of a resistance value and a temperature of the heater tool when a current is caused to flow to the heater tool before the first part and the second part are bonded;
a setting unit configured to derive, based on the at least one pair acquired by the acquisition unit, a resistance value of the heater tool when a temperature of the heater tool becomes a bonding temperature necessary for bonding the first part and the second part, and set the derived resistance value as a target resistance value; and
a control unit configured to measure a resistance value of the heater tool when the first part and the second part are bonded, and configured to control, when the first part and the second part are bonded, the power based on the measured resistance value so that a resistance value of the heater tool reaches the target resistance value.

2. The controller according to claim 1, wherein
the acquisition unit is configured to acquire, as the at least one pair, more than one pair of a resistance value and a temperature of the heater tool when different currents are caused to flow to the heater tool, and
the setting unit is configured to derive a correlation between a resistance value and a temperature of the heater tool based on the more than one pair, and drive, based on the derived correlation, the resistance value of the hater tool when the temperature of the hater tool becomes the bonding temperature.

3. The controller according to claim 2, wherein
the heater tool includes a heater tip configured to heat the work by contacting the work and generating heat, and a support member having a resistance lower than a resistance of the heater tip and configured to support the heater tip,
the acquisition unit is configured to acquire, as the resistance value of the more than one pair, a resistance value of the whole heater tool, and
the control unit is configured to measure, as the resistance value when the first part and the second part are bonded, a resistance value of the whole heater tool.

4. The controller according to claim 1, wherein the setting unit is configured to acquire a resistance temperature coefficient of the heater tool, and derive, based on the at least one pair and the resistance temperature coefficient, the resistance value of the heater tool when the temperature of the heater tool becomes the bonding temperature.

5. The controller according to claim 4, wherein
the heater tool includes a heater tip configured to heat the work by contacting the work and generating heat, and a support member having a resistance lower than a resistance of the heater tip and configured to support the heater tip, and
the setting unit is configured to acquire a resistance temperature coefficient of the heater tip as the resistance temperature coefficient of the heater tool.

6. The controller according to claim 1, wherein the acquisition unit is configured to acquire the at least one pair by performing, at least once, processing of causing the current to flow to the heater tool and measuring the resistance value and the temperature of the heater tool at the time of causing the current to flow.

7. The controller according to claim 6, wherein the acquisition unit is configured to measure the temperature at the time of causing the current to flow by a temperature sensor configured to detect a temperature of a contact portion with the work of the heater tool.

8. The controller according to claim 6, wherein
the acquisition unit is configured to acquire again at least one pair of a resistance value and a temperature by performing again, at least once, the processing of causing a current to flow to the heater tool and measuring a resistance value and a temperature after a first part and a second part of each of a plurality of works are bonded by performing control of power by the control unit, and
the setting unit is configured to derive again, based on the at least one pair acquired again by the acquisition unit, a resistance value of the heater tool when a temperature of the heater tool becomes the bonding temperature, and update, as the target resistance value, the resistance value derived again.

9. The controller according to claim 1, comprising a processor that functions as the acquisition unit, the setting unit, and the control unit.

10. A bonding system comprising:
a controller according to claim 1; and
a bonding apparatus controlled by the controller, including a heater tool, and configured to bond a first part and a second part by the heater tool.

11. A non-transitory computer-readable storage medium storing a program for causing a computer to function as a controller according to claim 1.

12. A setting method of setting a target resistance value in a controller configured to control power supplied to a heater tool configured to heat a work by generating heat by the power, thereby bond a first part and a second part of the work, wherein the controller is configured to measure a resistance value of the heater tool when the first part and the second part are bonded, and controls, when the first part and the second part are bonded, the power based on the measured resistance value so that a resistance value of the heater tool reaches the target resistance value, the method comprising:
performing, at least once, processing of causing a current to flow to the heater tool and measuring a resistance value and a temperature of the heater tool, thereby acquiring at least one pair of the resistance value and the temperature of the heater tool;
deriving, based on the acquired at least one pair acquired, a resistance value of the heater tool when a temperature of the heater tool becomes a bonding temperature necessary for bonding the first part and the second part; and
setting the derived resistance value as the target resistance value.
